(19) United States
(12) Patent Application Publication
(10) Pub. No.: US 2025/0034974 A1
(43) Pub. Date: Jan. 30, 2025

(54) USE OF CARBON MONOXIDE COMBINED WITH ADDITIVE GASES IN OIL RESERVOIRS

(71) Applicant: Paul B. Trost, Golden, CO (US)

(72) Inventor: Paul B. Trost, Golden, CO (US)

(21) Appl. No.: 18/784,214

(22) Filed: Jul. 25, 2024

Related U.S. Application Data
(60) Provisional application No. 63/515,961, filed on Jul. 27, 2023.

(51) Int. Cl. E21B 43/16; C09K 8/594

(52) U.S. Cl. CPC E21B 43/168; C09K 8/594

(57) ABSTRACT

Injecting into an oil reservoir a gaseous mixture of carbon monoxide (CO) together with additive gas, such as gaseous hydrocarbons comprising a mixture of one or more of methane (C1), ethane (C2), propane (C3), butane (C4), pentane (C5), and natural gasoline, (also referred to as NGL), flue gas, and/or nitrogen, for the purpose of achieving additional oil recovery from any of conventional, heavy, and unconventional oil reservoirs, including shale oil reservoirs. The injected gas mixture may range from 1% additive gas or additive gas mixture and 99% CO to 98.5% additive gas or additive gas mixture and 1.5% CO, all by volume.

### CROSS-REFERENCE

This application claims priority to U.S. provisional application 63/515,961 filed Jul. 27, 2023 and titled “USE OF CARBON MONOXIDE COMBINED WITH ADDITIVE GASES IN OIL RESERVOIRS,” the entire disclosure of which is incorporated herein by reference for all purposes.

### BACKGROUND

In conventional oil reservoirs, unconventional (shale oil) reservoir, and heavy oil reservoirs, oil is present in voids between the mineral grains but is also sorped onto the surface of the mineral grains. Oil may be sorped on mineral or even solid kerogen-like surfaces and held by capillary forces, van der Waals forces, polar interactions between the oil and adsorbing surfaces, and/or other forces. To extract the oil from these locations, pressure pushes the oil through extremely small permeability channels (pore throats) or fractures to a nearby well bore. Unfortunately, many permeability pore throats are smaller than the oil droplets, thus restricting the oil migration to the well bore. This is more common as the reservoir loses its natural or induced pressure, resulting in the oil droplets becoming effectively trapped. Quite often, pore throats are naturally lined with clays, some of which may be swelling clays such as smectite and montmorillonite. Thus, any compound or chemical that could effectively increase the diameter of the pore throats would be very beneficial to additional oil recovery.

Since many oil reservoirs also contain water, another problem for oil migration arises due to the relative permeability of the water as compared to that of oil. The water, generally being of lower viscosity and often a smaller molecule, will preferentially migrate through the small pore throats to the well bore. However, if a compound or chemical could act as a surfactant and lower the interfacial tension (IFT) between the oil and water, additional oil may also be dragged to the well bore resulting in increased oil recovery.

As production of oil continues and the reservoir ages, the relative mobility of gas in the reservoir far exceeds that of oil; thus, additional gas is obtained from the well. Such gas may, however, be beneficially employed to achieve additional oil production by the recovery, compression and re-injection of a portion of the gas into the reservoir. Re-pressurization of the formation and the presence of the gas may also act as a solvent for heavier oil molecules. Typically, reservoir gases containing C1-C6 and natural gasolines, generally referred to as NGLs (natural gas liquids) or “Y grade,” are reintroduced along with other associated hydrocarbons such as aromatic hydrocarbons like, but not limited to, benzene, xylene, toluene, and others. Alternately, gases containing only C2-C5 or C2-C6 may be preferred, depending on reservoir conditions. Another alternative is to only inject a portion of the NGLs, such as only ethane (C2) and/or propane (C3), or even just the methane (C1) along with agents such as surfactants.

Addition of NGL and NGL-type hydrocarbons has been documented and utilized over the past 70 years by various oil production operators.

### SUMMARY

Carbon monoxide, CO, geochemically interacts with the functional groups present in and on crude oil, especially aromatic molecules and asphaltenes. The benefits of the CO-hydrocarbon interaction include lowering of interfacial tension, increasing in rate of oil recovery, lowering operating costs of heavy oil recovery and recovering the heavy oil without heat, providing tubular protection against corrosion, and allowing operation at immiscible pressure conditions versus pure CO₂, which needs high pressure miscible conditions for a more rapid rate of oil recovery.

The present invention is thus directed to the addition (e.g., injection) of CO (carbon monoxide) as part of a gas mixture with one or more additive gases such as an NGL or NGL-type gas mixture, flue gas, and nitrogen, and in some embodiments also with CO₂, into oil reservoirs to recover additional oil from the reservoir, and/or alternately achieve a well bore remediation program. These gases (NGL or NGL-type or flue gas or nitrogen, and CO, and optionally CO₂) can be added to the reservoir pre-mixed, independently yet simultaneously, or independently and sequentially. Application of CO with this additive gas or additive gas mixture (NGL or NGL-type gas or any single NGL gas, or flue gas, or nitrogen), with optional CO₂, may be especially well suited for shale oil reservoirs, conventional reservoirs, and heavy oil reservoirs to increase the production of oil therefrom. Additionally, the co-injection of the CO and the additive gas or additive gas mixture may aid in the remediation of any undesirable black sludges or “schmoo” present in the reservoir, due to the attraction of the CO to asphaltenes, other hydrocarbons, or ferric ions that may be present, allowing recovery of the material.

The NGL or NGL-type gases are light hydrocarbon gases, such as C1-C5 (methane through pentane), C1-C6 (methane through hexane), or depending on reservoir conditions, C2-C5, or C2-C6. In some NGL-type gaseous mixtures, some heavier hydrocarbons such as C6-C8 or aromatics may be present. The individual concentration of each individual hydrocarbon component will generally be selected to maximize hydrocarbon recovery based upon each individual reservoir's mineralogy, chemical composition of the oil, and other parameters such as gas availability, reservoir pressures, temperatures, and numerous other existing reservoir conditions as may be determined. In some cases, any hydrocarbon may range from essentially de minimus (e.g., 0.1%) concentration or less, up to 95% of the NGL or NGL-type hydrocarbon mixture, with other hydrocarbons making up the remainder of the composition in varying proportions.

Flue gas, nitrogen (N₂), and nitrous oxides (e.g., N₂O) are the output gases from a hydrocarbon combustion process. Flue gas compositions are primary carbon dioxide (CO₂), nitrogen (N₂), nitrogen dioxide (NO₂), nitrous oxide (N₂O), oxygen (O₂), and water vapor. Typical flue gas from natural gas-fired power plants may contain 8-20% CO₂, 18-20% H₂O, 2-3% O₂, and 67-72% N₂, minor nitrous oxides, and trace CO generally being less than 1.5% in concentration. Typical flue gas from coal-fired boilers may contain 12-14 vol % CO₂, 8-10 vol % H₂O, 3-5 vol % O₂ and 72-77% N₂. Minute amounts of SOx and/or NOx may also be present.

Nitrogen (N₂) may be present not as part of a flue gas, but as its own gaseous stream. The nitrogen may be pure or essentially pure N₂, or may be a mixture with another gas component.

The CO may be pure, or essentially pure CO, or may be a mixture with at least two or more other gases in minor or major amounts, such as CO₂, and N₂. The CO₂, N₂, and H₂ are components, typically produced during the production of CO, and are usually no more than 50% by volume of the CO, usually no more than 20%.

As used herein, the phrase “additive gas or additive gas mixture” is used to encompass the NGL or NGL-type hydrocarbons, flue gas, and nitrogen gas. “Gas mixture,” and variations thereof, is used to designate the additive gas or additive gas mixture together with the CO.

The injected gas mixture includes at least 1.5% by volume CO, in some embodiments at least 5% by volume CO, in some embodiments at least 25% CO, in other embodiments at least 50% CO, and in other embodiments at least 75%. The additive gas or additive gas mixture and the CO (together, the gas mixture) may range from 1% gaseous hydrocarbons and 99% CO and associated minor gases including any of CO₂, H₂, N₂ to 98.5% gaseous hydrocarbons and 1.5% CO and associated minor gases. For example, the gas mixture may be 25%-60% CO with 40-75% additive gas or additive gas mixture, or be 25%-40% CO with 40-75% additive gas or additive gas mixture. In another example, the gas mixture may be 50-99% CO and 1-50% additive gas or additive gas mixture. In another example, the gas mixture may be 1-50% CO and 50-99% additive gas or additive gas mixture. In yet another example, the gas mixture may be 1.5%-50% CO and 50-98.5% additive gas or additive gas mixture. The particular percentage or ratio of CO to the additive gas or additive gas mixture is dependent on the reservoir's mineralogy and presence of impurities, chemical composition of the oil, and other parameters that are designed to achieve maximum oil recovery.

A purpose for mixing CO with light hydrocarbons as an additive gas is to achieve greater enhanced oil recovery by combining the unique benefits of the organic solvents coupled with the geochemical benefits of the CO. Mixing CO with N₂ and/or with flue gas additive gas achieves a synergistic effect of the physical chemical benefits of the N₂ with the geochemical benefits of the CO to more readily dissolve these gases into the oil and thereby lower the interfacial tension in the oil reservoir and thus recover more oil. These additive gases, coupled with the geochemical benefits of the CO to synergistically lower operating pressures, lower volumes of gases needed, increase rate and volume of oil recovery, and simultaneously achieve significantly higher returns on investment, enhance the project economics. The additive gases also may aid in the remediation of the black sludge that may be present in pore throats, downhole tubulars, surface tubulars and valving.

### DETAILED DESCRIPTION

As discussed above, when combined with CO, the injection of NGL or NGL-type gases (e.g., C1-C5, C2-C5, C2-C6, etc.) facilitates the extraction and removal of oil from reservoirs. Similarly, flue gases and nitrogen also facilitate the extraction and removal of oil from reservoirs. These injected gases help solubilize the heavier hydrocarbons, repressurize the reservoir, act as solvents for heavier hydrocarbons, open blocked pore throats, and lower overall oil viscosity.

Carbon monoxide (CO) has been shown by Trost to aid in oil recovery by providing both geochemical interactions with oil and the reservoir rock (see, e.g., U.S. Pat. Nos. 9,951,594 B2, 10,316,631 B2, and 10,876,384 B2, all of which are incorporated herein by reference). For instance, (1) CO has the capability of lowering the IFT by acting as a surfactant, (2) CO, a reducing agent, is capable of reacting with ferric iron in swelling clays to shrink the clays and thus increase pore throat diameters, (3) CO can alter oil wet reservoirs to water wet reservoirs due to its polarity and capability of liberating adsorbed hydrocarbons off of the reservoir mineral surfaces, (4) CO achieves swelling of the oil thus decreasing the viscosity of the oil, (5) CO adsorbs onto asphaltenes thereby partially liberating the associated long chain paraffins, resins, and other heavy oil molecules, (6) CO inhibits corrosion of oilfield tubulars, (7) CO reacts with free O₂ contained within injected fluids to convert them to CO₂, (8) CO has some solubility in crude oil, and being a small molecule, has been shown to aid in the faster recovery of the oil and to access lower permeability areas of the reservoir that have higher residual oil saturation, and (9) the presence of CO allows oil recovery at lower immiscible pressures thereby providing an economic advantage. These qualities and benefits are due to the introduction of CO into the reservoir.

Thus, a combination of additive gases or gas mixtures, such as NGL or NGL-type (e.g., methane (C1), ethane (C2), propane (C3), butane (C4), pentane (C5), hexane (C6)), N₂, and flue gases and CO, or CO with associated CO₂, results in a multifaceted approach to achieve additional or enhanced oil recovery and enhancement of project economics.

Injection of CO, in amounts greater than 1.5% by volume, and more preferably greater than 10% by volume, with the appropriate mixture of additive NGL or NGL-type gases, flue gases, and/or nitrogen, achieves additional oil recovery via a variety of physical and chemical methods. As shown by Trost, CO improves faster oil recovery as compared to pure CO₂, and the inclusion of the additive gas or additive gas mixture further improves the oil recovery. Furthermore, since oil recovery with CO can occur at significantly lower pressures than with pure CO₂, utilizing CO minimizes the loss of the injected gases to fractures and faults. Injection of methane, ethane, propane and heavier hydrocarbons (the NGL and NGL-type hydrocarbons) can repressurize the reservoir and aid in mobilization of the heavier hydrocarbons to the well bore. Flue gases and nitrogen can also repressurize the reservoir and aid in oil mobilization.

Due to the presence of the geochemical benefits of the CO with the additive gas or additive gas mixture, the injection and operating pressures of the gas mixture may be significantly decreased or lowered as compared to the current high pressures required in typical shale oil or other types of reservoirs. This is due to the CO shrinking swelled clays present in the reservoir that decrease pore throat diameter, coupled with the other CO benefits as previously listed. Injection pressures of the gas mixture are compatible with the reservoir's physical and chemical properties to achieve maximum oil recovery, typically under immiscible conditions. The decrease in pressure may be as much as a 80% reduction, although in some environments, only a 10-40% reduction is obtained, which is a noticeable reduction nonetheless. Lowering of injection and operating pressures is highly economically beneficial, and lessens the risk of the injected gases escaping through fractures or other high permeability zones.

Although CO, carbon monoxide, is a relatively common molecule, sources of large volumes of CO are typically not available in suitable proximity to oil reservoirs. Onsite generation of the CO is therefore desired due to the very large volumes of CO required. Typically, CO is generated by the burning of other hydrocarbons such as coal, oil, gaseous hydrocarbons, flared natural gas or casing head gas, petcoke, or other low-cost organic fuel. The typical processes to produce CO, and slight variations thereof, are generally referred to as syngas, pyrolysis, reforming, or burners; these processes produce byproducts of hydrogen (H₂), nitrogen (N₂), and CO₂. The syngas process, reforming process, burners or other non-combustion processes that reduce CO₂ to CO may occur on site or nearby, to provide the CO for injection into the oil reservoir.

Often, the process to produce the CO can be referred to as a “green” process. As a syngas process produces significant heats of combustion, this heat of combustion can be captured and converted into electrical energy for use on site or sold. Since the CO and CO₂ products of syngas are injected downhole, and the H₂ recovered for economic benefit, if desired, the electrical generation associated with CO and CO₂ generation essentially results in emitting zero or de minimus greenhouse gas emissions, e.g., due to sequestration within the reservoir.

Another “green” environmental benefit is to utilize the produced hydrocarbon gases and liquids available from adjacent wells and/or pipelines, materials that are typically flared resulting in significant greenhouse gas emissions. These previously-flared gases can be used in the present process by: (1) separating and recovering the desired hydrocarbons, (2) burning the recovered hydrocarbons to produce CO and CO₂, for combining with the NGLs and aiding oil recovery, and/or (3) injecting the recovered light hydrocarbons into the reservoir. Environmental benefits and/or economic credits may be available due to sequestration of the previously-flared waste gases and the resulting CO, CO₂. Thus, the environmental liability of flaring/burning the waste gas is converted to an environmentally and economically beneficial cause, by eliminating the emission of greenhouse gases and sequestration of the CO₂ and CO within the reservoir coupled with enhanced oil recovery or well bore remediation.

Historically, compression costs of gases for injection into the reservoir are expensive. On-site production of CO and optionally CO₂, N₂ and/or H₂ (e.g., via a syngas or other processes such as burning coal or petcoke) results in significant heat of combustion; this heat can be readily converted to emission-free electrical energy that can be used for many purposes, including compression of the injection gases. (It is noted that it was found that by combining CO with N₂, the compression costs typically decrease 30-80%). Capture of the heat of combustion and conversion to electrical energy, for any use, results in zero emission electrical power available on site.

Temperature of the injected gases (i.e., the additive gas or gas mixture and CO, at least) may vary widely and range from the exit temperature of the injection compressor down to ambient temperature. In certain cases, especially where the well bore perforations may be plugged, the gases may be heated above the outlet temperature of the compressor to achieve a faster reaction rate in the reservoir and improve well bore cleanup; this heating may be done, e.g., by the heat or electricity obtained from the previously-flared gases.

For shale oil recovery, horizontal wells are typically drilled parallel to each other during the development of a shale oil field. Occasionally, the introduced frac fluids in the newly drilled adjacent well may interact with the frac fluids and formation water of an earlier well, or with the reservoir rock in the newly drilled well, thereby creating a black sludge commonly referred to in the industry as “schmoo,” “black sludge,” “goo,” or other such names. This black sludge inhibits the production of oil by blocking the pore throats and natural or produced fractures through which the oil is transported to the well bore. The schmoo or black sludge may also be present in the wellbore tubulars, surface tubulars, valves, and tanks.

The oil industry has shown this black sludge is stabilized by the presence of ferric oxides and/or hydroxides, asphaltenes, which may be a coating of ferric oxides or hydroxides on fine particles of reservoir matrix. The composition of the black sludge varies widely, but may include ingredients from the injected frac fluids such as polymers, friction reducers, oxygen scavengers, breakers, surfactants, gelling agents, inorganic compounds for pH adjustment and other organic chemicals such as asphaltenes. Thus, the injection of CO facilitates the reduction the ferric oxides and hydroxides to ferrous oxide and assists in the disaggregation of the sludge to open up pore throats and achieve additional oil flow to the well bore. Additionally, because of the effects of CO on heavy hydrocarbons, such as asphaltenes, which may form part of the “schmoo,” black sludge or other ferric-stabilized or adverse precipitates, CO may assist in the dissolution and optionally eventual recovery of the material to improve reservoir permeability in those partially or totally plugged reservoir areas. To further aid remediation of the reservoir, additional reagents such as acids, bases, surfactants, polymer breakers and other organic solvents may also be co-injected with the CO.

Therefore, the combination of CO, and optional amounts of CO₂, with light end hydrocarbons such as NGL or NGL-type hydrocarbons, flue gases, and/or nitrogen, at various ratios as determined by the oil and reservoir properties, achieves both increased oil recovery as an EOR (Enhanced Oil Recovery) process and also aids in the treatment of the “schmoo” or sludge.

For remediation of the “schmoo” or other pore throat-plugging sludges, the CO, either essentially alone or optionally with CO₂, and the additive gas(es) are injected into the reservoir (e.g., shale oil reservoir, conventional reservoir, or heavy oil reservoir) as a gas mixture at rates and pressures as determined for individual reservoir conditions to achieve dispersion into the reservoir. Preferably, the CO, either as a single component, or CO with minor CO₂, wherein the contained CO₂ will typically, but not always, be less than 50% by volume of the total injected gas, is injected together downhole. By injecting the CO alone, or nearly alone, it could act as a spearhead by having a higher concentration and faster effect on achieving a chemical interaction with the black sludge or other pore blocking sludges.

Preferably the CO, and any CO₂ and other minor gases, are produced onsite, such as by utilizing waste or flared gas. Using the flared gas to instead produce the CO avoids greenhouse gas emissions associated with flaring. If flared, the flue gases from the flared gas can be used with the CO. Thus, the non-flaring and subsequent conversion of the hydrocarbons to CO and possibly CO₂, and the use of any flue gases, provides sequestration and thus greenhouse gas reduction, possibly elimination.

The gas mixture injected into the oil reservoir bore hole includes at least 1.5% by volume CO (including any minor amounts of CO₂, N₂, H₂), in some embodiments at least 5% CO, in some embodiments at least 25% CO, in other embodiments at least 50% CO. For example, the gas mixture may be 25%-60% CO with 40-75% additive gas or additive gas mixture. In another example, the gas mixture may be 50-99% CO and 1-50% additive gas or additive gas mixture. In another example, the gas mixture may be 1-50% CO and 50-99% additive gas or additive gas mixture. As specific examples, the gas mixture may be 25%-40% CO with 40-75% NGL or NGL-type gases and/or N₂ and/or flue gas; 50-99% CO and 1-50% NGL or NGL-type gases and/or N₂ and/or flue gases; or 1-50% CO and 50-99% NGL or NGL-type and/or N₂ and/or flue gases.

Depending on the additive gases, a 50%-50% gas mixture has a ratio of 1:1 CO to hydrocarbons; other example ratios include 1:2, 1:3, 2:3, 2:1, 3:1, and 3:2 CO to hydrocarbons. The concentration of the CO and the additive gas or additive gas mixture is selected to maximize hydrocarbon recovery based upon each individual reservoir's mineralogy, chemical composition of the oil, and other parameters such as gas availability, reservoir pressures, temperatures, and numerous other existing reservoir conditions as may be determined.

The gas mixture may include an amount of CO₂, for example 1% CO₂, in some embodiments at least 10% CO₂. The ratio of CO₂:CO may be, e.g., 1:2, or 1:4, or 1:5. The CO₂ is typically less than 50% of the CO and typically less than 30% of the total gas mixture, although on rare occasions could be as high as 50% of the total gas mixture. The CO₂ is less than 20% of the total gas mixture for “schmoo” or other ferri-stabilized sludges.

As indicated above, the gas mixture may include NGL and/or NGL-type hydrocarbons, which includes light hydrocarbon gases, ranging from C1-C6 (methane through hexane), natural gasoline, and/or flue gas, and/or nitrogen. In some embodiments aromatic hydrocarbons such as, but not limited to benzene, toluene, xylene, etc. may be present.

The gas mixture may include at least 10% of C1-C6, in any ratio from 0.1-100% for individual components (e.g., 20% of each of C1, C2, C3, C4, C5; e.g., 20% of each of C2, C3, C4, C5, C6; e.g., 25% C1, 25% C2, 20% C3, 10% C4, 10% C5, 10% C6), in some embodiments at least 25% of the gas mixture. In some embodiments, the amount of each or any of C2-C6 is more than the amount of C1 present.

In one example, particularly for remediation of black sludge, the gas mixture may be at least 50% CO with the remainder of the gas mixture the additive gases, including e.g., C1-C5 hydrocarbons. Particularly for black sludge, surfactants and/or other inorganic substances such as, but not limited to, sodium bicarbonate or sodium carbonate, or other ionic species, may be included to break the emulsion. An example gas mixture is 50% by volume CO and 50% by volume additive gas or additive gas mixture, which is a 1:1 ratio; in other embodiments, the ratio is 2:1 or 3:2. In some embodiments, the additive gas mixture will be composed of C2-C5 or C2-C6 with minimal CL. The total C2-C6 hydrocarbons may also be present at a ratio to CO of, e.g., 1:1, 1:2, 2:3. In another embodiment, the CO, and associated CO₂ and H₂, having concentrations ranging from 5%-49% of the total gas mixture, and the associated hydrocarbons such as C2-C5, or C2-C6 will be injected.

For treatment of the black sludge, additional aromatic hydrocarbons may also be included with the injected additive gas(es) and CO gas mixture. As an example, but not limited to, benzene, toluene, xylene, acetone, or other hydrocarbons that may help dissolve and/or disperse the black sludge. Additionally, or alternately, heavier hydrocarbons, e.g., C6-C8, may be present. The amount of any C6-C8 and aromatics, combined, is typically less than 25% by volume of the gaseous mixture.

For flue gas and N₂, the gas mixture may include at least 10% of either additive gas or a combination of the gases, in some embodiments one or both of these additive gases are at least 25% of the gas mixture. In some embodiments, the amount of the combination of these additive gases is at least 50%, up to about 90% and even up to about 99% of the gas mixture. For N₂ as the additive gas, in some embodiments, the resulting gas mixture is 15-35% CO and 65-85% N₂.

Oil recovery by pure N₂ typically requires operating and injection pressures to be very high (e.g., 4000-8000 psi) to achieve miscibility, but due to the presence of the CO with N₂, the operating pressures can be as low as 350 psi, but more typically 900-1500 psi thereby operating in an immiscible mode. The presence of effective concentrations of this additive gas (either as pure or essentially pure N₂ or as part of flue gas) greater than 1.5% by volume and more, e.g., in the range of 20-30%, results in faster and greater oil recovery rates at lower pressures than if the additive gas were not used with the CO.

Having CO in a gas mixture with the additive gas N₂, and optionally also with CO₂, can recover equivalent volumes of oil under immiscible conditions as compared to CO₂'s miscible conditions. Also, the mixture of CO and N₂, optionally with CO₂, is tolerant to the presence of other gases such as CH₄, Ar, and even O₂, at concentrations up to 15% by volume in the gas mixture.

Laboratory studies of the effects of the addition of N₂ gas to CO for oil recovery are shown in Table 1. This shows poorer recovery of oil under pure N₂ conditions and enhancement when CO₂+CO is present with the N₂ as shown in Table 1.

The objectives of this experiment were to evaluate the effects of pure N₂ compared to a gas mixture having 33% CO/CO₂ and 67% N₂ and to a gas mixture of CO/CO₂. The tests were done with 36° API oil at an operating pressure of 500 psi, a simulated reservoir temperature of 98° F., using a “Huff-n-Puff” oil recovery method with soak period of 72 hours, with a pore volume of 59 ml for the slim tube.

TABLE 1
ENHANCED OIL RECOVERY WITH A
COMBINATION OF N2 AND CO/CO2

| | 100% N₂ | 67% N₂ + 11% CO + 22% CO₂ |
|---|---|---|
| ml oil recovered | 39.6 | 46 |
| Recovery Factor | 81% | 96% |

The results show that the combination of CO and CO₂ with N₂ is beneficial over pure N₂ alone, showing the benefits of CO with CO₂ in oil production.

In addition to the CO and the additive gas(es), certain additional chemicals may be added to the gas mixture as liquids such as acids, bases, surfactants, polymer breakers, and others to further aid dissolution of the black sludge and aid oil recovery. These additives may vaporize when injected into the reservoir or may be liquid droplets carried by the gaseous mixture.

The above specification and examples provide a complete description of the structure and use of exemplary embodiments of the invention. The above description provides specific embodiments. It is to be understood that other embodiments are contemplated and may be made without departing from the scope or spirit of the present disclosure. The above description, therefore, is not to be taken in a limiting sense. For example, elements or features of one example, embodiment or implementation may be applied to any other example, embodiment or implementation described herein to the extent such contents do not conflict.

For example, the above specification provides for injection of a combination of CO, and minor amounts of CO₂, together with additive gas(es) than may include light hydrocarbons such as C1-C6 (methane through hexane and natural gasoline) and some heavier hydrocarbons such as C6-C8 or aromatics, to achieve additional oil recovery from unconventional shale oil reservoirs, conventional, and heavy oil reservoirs. This additional oil recovery can be measured as increased rate of oil production and/or as an increased total amount of oil production. The concentrations of the CO and additive gas or additive gas mixture will vary depending on the chemical characteristics of the reservoir and the oil, but typically the CO will be greater than 5% of the injected CO/additives, more typically the CO concentration will be closer to 25-40% of the total gas volume injected. The specification also provides that injection of the CO and additive gas or additive gas mixture, as a well bore remediation process and/or for treatment of the black sludge, may be in concentrations of 50% CO to almost 100% CO, with any remaining being light end hydrocarbons and/or N₂ and/or CO₂ and/or H₂. The gas mixture of CO and additive gas or additive gas mixture, when used for a well bore remediation process and/or for treatment of black sludge and/or for additional oil recovery, may also contain certain other chemicals to facilitate the breakup of the black sludge, such chemicals being bases (e.g., sodium carbonate and bicarbonate), organic solvents, surfactants, acids, and polymer breakers, but not limited to the above.

A purpose of mixing CO with the additive gas or additive gas mixture is to achieve greater enhanced oil recovery by combining the unique benefits of the organic solvents and the numerous benefits of CO, thereby achieving a better symbiotic results and increasing oil recovery, the increased oil recovery being increased oil production rate and/or increased total volume oil produced. The use of CO in addition to NGL or NGL-type gases, flue gas, nitrogen, or other gases, allows injection and/or operating at pressures up to 80% less than when not using CO and such additive gases, while still recovering equivalent amounts of oil and lower costs.

While the present disclosure is not so limited, an appreciation of various aspects of the disclosure will be gained through a discussion of the examples provided above and the claims that follow.

1. A method of oil extraction from an oil reservoir, comprising:
injecting into the oil reservoir a gaseous mixture of 1.5% to 99% by volume carbon monoxide (CO) and 1% to 98.5% by volume additive gas comprising one or more of NGL-gas or NGL-type gas, flue gas, and nitrogen (N₂).

2. The method of claim 1, wherein the additive gas comprises one or more of methane (C1), ethane (C2), propane (C3), butane (C4), pentane (C5), hexane (C6), and natural gasoline.

3. The method of claim 1, wherein the additive gas comprises N₂.

4. The method of claim 1, wherein the gaseous mixture includes 0.1-50% by volume CO₂.

5. The method of claim 1, wherein the gaseous mixture includes 0.1-30% by volume CO₂.

6. The method of claim 1, wherein the oil reservoir is one of a conventional reservoir, a heavy oil, or unconventional oil reservoir.

7. The method of claim 6, wherein the oil reservoir includes black sludge present therein, and wherein injecting the gaseous mixture remediates the black sludge.

8. A method comprising:
producing gaseous carbon monoxide (CO) proximate an oil reservoir well bore from a hydrocarbon source;
combining the produced CO with at least one additive gas comprising one or more of methane (C1), ethane (C2), propane (C3), butane (C4), pentane (C5), hexane (C6), natural gasoline, carbon dioxide (CO₂), oxygen (O₂), and nitrogen (N₂) to produce a gaseous mixture of 1.5% to 99% by volume carbon monoxide (CO) and 1% to 98.5% by volume additive gas; and
injecting the gaseous mixture into the oil reservoir.

9. The method of claim 8, wherein producing gaseous CO comprises operating a syngas process, reforming, or a burner process.

10. The method of claim 9, wherein producing gaseous CO from the syngas process or the reforming process comprises producing electricity from heat produced by the syngas process, reforming, or burner process.

11. The method of claim 8, wherein producing gaseous CO from a hydrocarbon source comprises producing gaseous CO from a waste hydrocarbon stream.

12. The method of claim 8, wherein producing gaseous CO proximate an oil reservoir well bore comprises emitting no greenhouse gases.

13. The method of claim 8, wherein the gaseous mixture comprises 1.5% to 99% CO and 1% to 98.5% the gaseous hydrocarbons.

14. The method of claim 8, wherein the gaseous mixture comprises 1.5% to 99% CO and 1% to 98.5% N₂.

15. The method of claim 8, wherein the oil reservoir is one of a conventional reservoir, a heavy oil, or unconventional oil reservoir.

16. The method of claim 15, wherein the oil reservoir includes black sludge present therein, and wherein injecting the gaseous mixture remediates the black sludge.
